(19) United States
(12) Patent Application Publication
(10) Pub. No.: US 2015/0049372 A1
(43) Pub. Date: Feb. 19, 2015

(54) Free-Space Dynamic Diffractive Projection Apparatus

(71) Applicant: Forward Electronics Co, Ltd., Taipei (TW)

(72) Inventors: Yu Wen CHEN, New Taipei City (TW); Hsien Chih CHIU, New Taipei City (TW)

(73) Assignee: Forward Electronics Co, Ltd., Taipei (TW)

(21) Appl. No.: 14/141,824

(22) Filed: Dec. 27, 2013

(30) Foreign Application Priority Data
Aug. 16, 2013 (TW) 102129452

(51) Int. Cl. G03B 21/14; G02B 5/32

(52) U.S. Cl. CPC G03B 21/142; G02B 5/32
USPC 359/15; 353/85; 353/31

(57) ABSTRACT

A free-space dynamic diffractive projection apparatus comprises a laser light source element, a dynamic diffractive element, a control element, and a signal output element. Based on a pattern signal outputted from the signal output element, the control element controls the laser light source element to emit a color beam, and controls the dynamic diffractive element to perform real-time signal modulation so as to generate different dynamic diffractive grating distributions in a specific period. Accordingly, the color beam passes through the dynamic diffractive element to produce the pixels defined by the pattern signal in a specific space. The control element controls the dynamic diffracting element to be quickly switched to display each pixel, so that each pixel is projected on a corresponding position in a specific space to form a two-dimensional geometric image.

### BACKGROUND OF THE INVENTION

1. Field of the Invention

The present invention relates to an image projection apparatus and, more particularly, to a free-space dynamic diffractive projection apparatus with lower energy loss.

2. Description of Related Art

Generally, laser has the advantages of high intensity, narrow band, and centralized light beam for providing high brightness, high color saturation, and high resolution in image projection. Therefore, laser is one of the best choices for light source of an image projection apparatus. Accordingly, the image projection apparatus using laser as a light source has become a tendency in display technology. The key element, i.e. the micro scanner, of the laser micro projection apparatus is a highly micro electromechanical system (MEMS), which is difficult in manufacture and thus is expensive. Furthermore, the existent micro scanner is based on Lissajous scan or raster scan to generate a full projection screen. However, for some geometric patterns, such as a rectangle or a circle, it is only required to project image in a small part of the projection area. Unfortunately, the configuration of the conventional mechanical micro scanner is unable to choose scanning positions, such that the micro scanner may redundantly scan the part of the transmission area on which no image is required to form, resulting in unnecessary energy loss.

In addition, with regard to the construction sites, a laser level is the most common used tool for measuring horizontal line. The laser level can project horizontal or vertical line markings to measure horizontal lines, gaps, or vertical lines for construction ground, floors, walls or ditches, or even to measure horizontal lines, gaps, or vertical lines on different walls and other construction sites, so as to solve the problems of complicated operating procedure and lower accuracy encountered in the prior art that uses a typical ruler for measurement. Furthermore, please refer to FIG. 1, which is a schematic diagram of a prior laser level. As shown in FIG. 1, a laser level 1 has a plurality of laser emitting heads 10 for projecting a beam reticle 11 on a wall 12. Such a laser level 1 can solve the problems caused by using a typical ruler for measurement, i.e., complicated operating procedure, lower accuracy, etc.

However, the aforementioned laser level 1 only can provide the reticle of points or lines in use. In actual application, the measurement in construction sites is not restricted only to one-dimensional object, such as horizontal line, gap, vertical line, etc., but may be required for different two-dimensional construction arrangements to be measured, such as a rectangle, a circular, and a circular arc. The prior laser level is unable to perform image projection for such two-dimensional patterns.

Therefore, it is desirable to develop a free-space dynamic diffractive projection apparatus, so that laser beams passing through the dynamic diffractive optical element can be controlled to directly produce a two-dimensional dynamic diffractive geometric pattern, thereby replacing the conventional technique of using the micro scanner to produce two-dimensional dynamic image by scanning and projecting. Furthermore, unnecessary energy loss can be avoided because there is no need to repeatedly scan the part of transmission area on which no image is projected.

### SUMMARY OF THE INVENTION

The object of the present invention is to provide a free-space dynamic diffractive projection apparatus for controlling laser beams passing through the dynamic diffractive optical element of the present invention to directly produce a two-dimensional dynamic diffractive geometric pattern, so as to replace the conventional technique of using a micro scanner to produce a two-dimensional dynamic image by scanning and projecting, and to be free from redundantly scanning the part of the transmission area on which no image is formed, thereby avoiding unnecessary energy loss.

According to one aspect of the present invention, there is provided a free-space dynamic diffractive projection apparatus, which comprises a laser light source element for providing a color beam having a light intensity; a dynamic diffractive optical element corresponding to the laser light source element for receiving the color beam; a control element electrically coupled with the laser light source element and the dynamic diffractive optical element for dynamically adjusting the light intensity, wherein the control element controls the dynamic diffractive optical element to perform real-time signal modulation for producing dynamic diffractive grating distributions, so that the color beam passes through the dynamic diffractive optical element, for producing a pixel corresponding to a predetermined position of a specific space; and a signal output element electrically connected to the control element for outputting a pattern signal to the control element, wherein the pattern signal defines a plurality of pixels corresponding to a two-dimensional geometric image; wherein the control element is based on the pattern signal to control the dynamic diffractive optical element in a specific period to perform real-time signal modulation for producing different dynamic diffractive grating distributions, so that the color beam passes through the dynamic diffractive optical element for producing the plurality of pixels in the specific space as defined by the pattern signal; and the control element controls the dynamic diffractive optical element to be quickly switched to display each pixel, so that each pixel is projected on the corresponding position in the specific space to form the two-dimensional geometric image by scanning.

According to another aspect of the present invention, there is provided a free-space dynamic diffractive projection apparatus, which comprises a first laser light source element for providing a first color beam having a first light intensity; a second laser light source element for providing a second color beam having a second light intensity; a third laser light source element for providing a third color beam having a third light intensity; a first dynamic diffractive optical element corresponding to the first laser light source element for receiving the first color beam; a second dynamic diffractive optical element corresponding to the second laser light source element for receiving the second color beam; a third dynamic diffractive optical element corresponding to the third laser light source element for receiving the third color beam; a control element electrically coupled with the first, second and third laser light source elements and the first, second and third dynamic diffractive optical elements, for respectively dynamically adjusting the first, second and third light intensities, wherein the control element respectively controls the first, second and third dynamic diffractive optical elements to perform real-time signal modulation for producing dynamic diffractive grating distributions, so that the first, second and third color beams passes through the first, second and third dynamic diffractive optical elements, respectively, for producing a pixel corresponding to a specific position of a specific space; a combiner for allowing the first, second and third color beams to be combined at the corresponding specific position after passing through the first, second and third dynamic diffractive optical elements, respectively; and a signal output element electrically connected to the control element for outputting a pattern signal to the control element, wherein the pattern signal defines a plurality of pixels corresponding to a two-dimensional geometric image; wherein the control element is based on the pattern signal respectively to control the first, second and third dynamic diffractive optical elements in a specific period to perform real-time signal modulation for producing different dynamic diffractive grating distributions, so that the first, second and third color beams pass through the first, second and third dynamic diffractive optical elements, for producing the plurality of pixels in the specific space as defined by the pattern signal, respectively, and the control element respectively controls the first, second, and third dynamic diffractive optical elements to be quickly switched to display each pixel, so that each pixel is projected on the corresponding position in the specific space to form the two-dimensional geometric image by scanning.

According to a still another aspect of the present invention, there is provided a free-space dynamic diffractive projection apparatus, which comprises a first laser light source element for providing a first color beam having a first light intensity; a second laser light source element for providing a second color beam having a second light intensity; a third laser light source element for providing a third color beam having a third light intensity; a combiner for receiving the first, second, and third color beams and combining the first, second and third color beams into a combined beam; a dynamic diffractive optical element for receiving the combined beam; a control element electrically coupled with the first, second and third laser light source elements and the dynamic diffractive optical element, for respectively dynamically adjusting the first, second, and third light intensities, wherein the control element controls the dynamic diffractive optical element to perform real-time signal modulation for producing dynamic diffractive grating distributions, so that the combined beam passes through the dynamic diffractive optical element, for producing a pixel corresponding to a predetermined position of a specific space; and a signal output element electrically connected to the control element for outputting a pattern signal to the control element, wherein the pattern signal defines a plurality of pixels corresponding to a two-dimensional geometric image; wherein the control element is based on the pattern signal to control the diffractive optical element in a specific period to perform real-time signal modulation for producing different dynamic diffractive grating distributions, so that the combined beam passes through the dynamic diffractive optical element for producing the plurality of pixels in the specific space as defined by the pattern signal, and the control element controls the dynamic diffractive optical element to be quickly switched to display each pixel, so that each pixel is projected on the corresponding position in the specific space to form the two-dimensional geometric image by scanning.

According to a further aspect of the present invention, there is provided a free-space dynamic diffractive projection apparatus, which comprises a light source module for providing a collimated beam; a hologram set including a plurality of holograms defined a plurality of pixels corresponding to a two-dimensional geometric image, wherein each hologram has static diffractive grating distribution, so as to produce a static diffractive image when the collimated beam passes through each of the holograms; and a player for fast playing the plurality of holograms for allowing the static diffractive images produced from the plurality of holograms to be presented as a dynamic image, so as to form the two-dimensional geometric image.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a prior laser level;

FIG. 2 is a schematic diagram of the free-space dynamic diffractive projection apparatus according to a preferred embodiment of the present invention;

FIG. 3 is a flow chart showing the image displayed on an object according to the free-space dynamic diffractive projection apparatus of a preferred embodiment of the present invention;

FIG. 4 is a schematic diagram showing the image displayed on the object according to the free-space dynamic diffractive projection apparatus of a preferred embodiment of the present invention;

FIG. 5 is a schematic diagram of the free-space dynamic diffractive projection apparatus according to another preferred embodiment of the present invention;

FIG. 6 is a schematic diagram of the free-space dynamic diffractive projection apparatus according to a still another preferred embodiment of the present invention; and

FIG. 7 is a schematic diagram of the free-space dynamic diffractive projection apparatus according to a further preferred embodiment of the present invention.

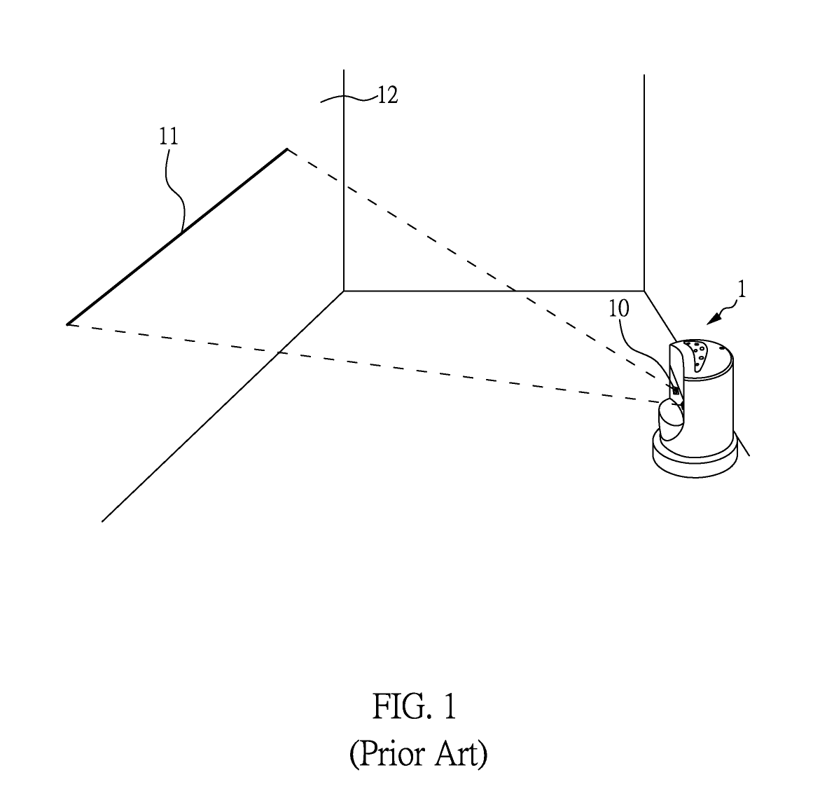

### DETAILED DESCRIPTION OF THE PREFERRED EMBODIMENT

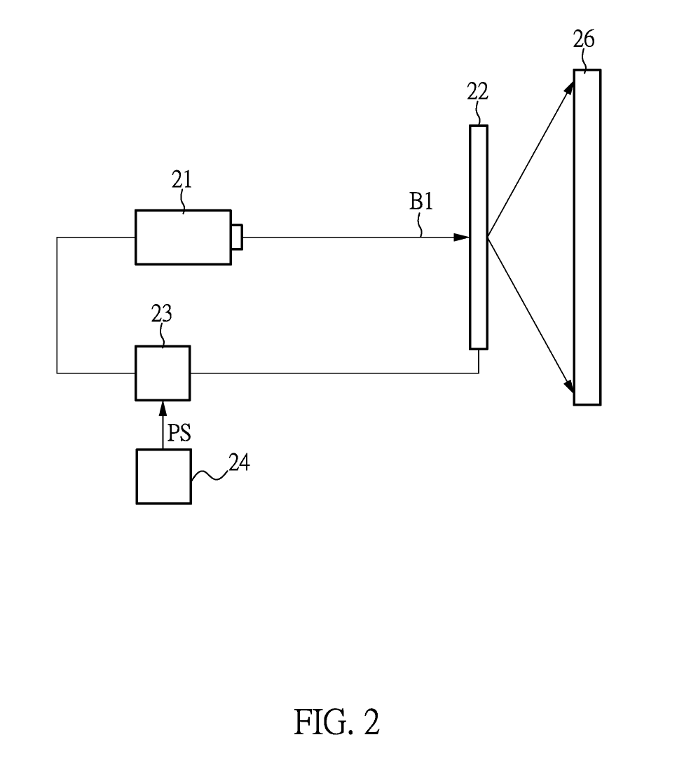

Please referred to FIG. 2, there is shown a schematic diagram of the free-space dynamic diffractive projection apparatus according to a preferred embodiment of the present invention. As shown in FIG. 2, a free-space dynamic diffractive projection apparatus comprises a laser light source element 21, a dynamic diffractive optical element 22, a control element 23, and a signal output element 24.

The laser light source element 21 provides a color beam B1 having a light intensity. In this embodiment, the color beam B1 is a collimated beam, and the color beam B1 may be a red beam, a blue beam, a green beam or a monochrome beam, etc. The dynamic diffractive optical element 22 corresponds to the laser light source element 21 for receiving the color beam B1, wherein the dynamic diffractive optical element 22 may be a spatial light modulator, or a dynamic grating. In this embodiment, the dynamic diffractive optical element 22 is a spatial light modulator. The control element 23 is electronically coupled with the laser light source element 21 and the dynamic diffractive optical element 22 for dynamically adjusting the light intensity of the color beam B1, wherein the control element 23 controls the dynamic diffractive optical element 22 to perform real-time signal modulation for producing dynamic diffractive grating distributions, so that the color beam B1 passes through the dynamic diffractive optical element 22 to produce a pixel corresponding to a predetermined position of a specific space. The signal output element 24 is electrically connected to the control element 23 for outputting a pattern signal PS to the control element 23. In this embodiment, the pattern signal PS defines a plurality pixels corresponding to a two-dimensional geometric image, which may be a rectangle, a circular, an ellipse, a trapezoid, a polygon, a cruciform, or a circular arc.

The control element 23 is based on the pattern signal PS to control the dynamic diffractive optical element 22 in a specific period to perform real-time signal modulation for producing different dynamic diffractive grating distributions, so that the color beam B1 passes through the dynamic diffractive optical element 22 to produce the plurality of pixels in the specific space as defined by the pattern signal, and the control element 23 controls the dynamic diffractive optical element 22 to be quickly switched to display each pixel, so that each pixel is projected on a corresponding position in the specific space to form a two-dimensional geometric image on an object 26 by scanning.

Therefore, according to the free-space dynamic diffractive projection apparatus of the present invention, based on the received pattern signal, the control element is able to control the laser beam passing through the dynamic diffractive optical element to directly produce a two-dimensional dynamic diffractive geometric pattern, so as to replace the conventional technique of using a micro scanner to produce the two-dimensional dynamic image by scanning and projecting. Furthermore, the free-space dynamic diffractive projection apparatus of the present invention does not need to redundantly scan the part of the transmission area on which no image is formed, so as to avoid unnecessary energy loss.

Furthermore, the free-space dynamic diffractive projection apparatus of the present invention can be substantially used in construction sites for measurement, wherein it is used not only for one-dimensional measurement, such as a horizontal line, a vertical line, and a gap, but also for different two-dimensional measurement, such as a rectangle, a circular, and a circular arc.

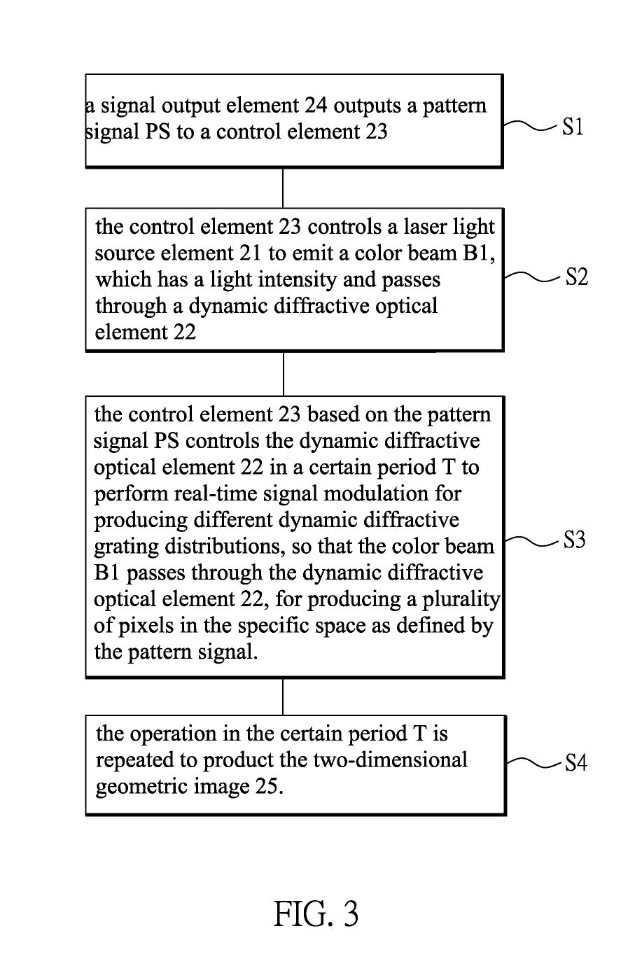

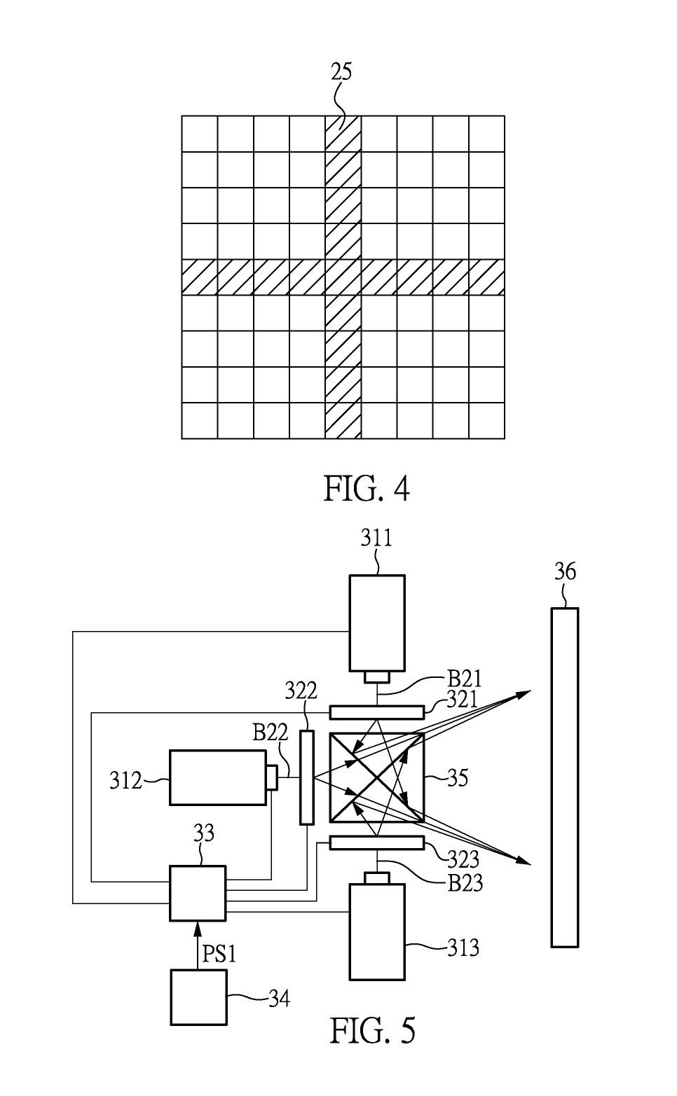

In order to further illustrate the operation of the free-space dynamic diffractive projection apparatus in this embodiment, please refer to FIG. 3 and FIG. 4, which are respectively a flow chart and a schematic diagram showing the image displayed on the object. With reference to FIG. 3 as well as FIG. 2, first, in step S1, a signal output element 24 outputs a pattern signal PS to a control element 23. In step S2, the control element 23 controls a laser light source element 21 to emit a color beam B1 having a light intensity to pass through a dynamic diffractive optical element 22. In a step 3, the control element 23 is based on the pattern signal PS to control the dynamic diffractive optical element 22 in a specific period T to perform real-time signal modulation for producing different dynamic diffractive grating distributions, so that the color beam B1 passes through the dynamic diffractive optical element 22 to produce a plurality of pixels in the specific space as defined by the pattern signal. For example, as shown in FIG. 4, a two-dimensional geometric image 25 corresponding to the pattern signal PS is a cross shape. In the specific period T, the plurality of pixels defined by the pattern signal PS are randomly produced with the control element 22 controlling the dynamic diffractive optical element 22 to perform real-time signal modulation for producing different dynamic diffractive grating distributions until all of the pixels constituting the two-dimensional geometric image 25 are completely produced. In step S4, the operation in the specific period T is repeated to product and display the two-dimensional geometric image 25.

Please refer to FIG. 5, which is a schematic diagram of the free-space dynamic diffractive projection apparatus according to another preferred embodiment of the present invention. As shown in FIG. 5, the free-space dynamic diffractive projection apparatus comprises a first laser light source element 311, a second laser light source element 312, a third laser light source element 313, a first dynamic diffractive optical element 321, a second dynamic diffractive optical element 322, a third dynamic diffractive optical element 323, a control element 33, a coupler 35, and a signal output element 24.

The first laser light source element 311, the second laser light source element 312, and the third laser light source element 313 are disposed at locations so that the laser light source outputs thereof are perpendicular to each other. The first laser light source element 311 provides a first color beam B21 having a first light intensity. The second laser light source element 312 provides a second color beam B22 having a second light intensity. The third laser light source element 313 provides a third color beam B23 having a third light intensity. In this embodiment, the first color beam B21 is preferably a red beam, the second color beam B22 is preferably a green beam, and the third color beam B23 is preferably a blue beam.

The first dynamic diffractive optical element 321 is disposed at a location to which the first laser light source element 311 outputs laser beam, for corresponding to the first laser light source element 311 to receive the first color beam B21. The second dynamic diffractive optical element 322 is disposed at a location to which the second laser light source element 312 outputs laser beam, for corresponding to the second laser light source element 312 to receive the second color beam B22. The third dynamic diffractive optical element 323 is disposed at a location to which the third laser light source element 313 outputs laser beam, for corresponding to the third laser light source element 313 to receive the third color beam B23. In addition, the first, second, and third dynamic diffractive optical elements 321, 322, 323 may be each a spatial light modulator or a dynamic grating. In this embodiment, the first, second, and third dynamic diffractive optical elements 321, 322, 323 are each a dynamic grating.

The control element 33 is coupled with the first, second and third laser light source elements 311, 312, 313 and the first, second and third dynamic diffractive optical elements 321, 322, 323 for respectively dynamically adjusting the first, second and third light intensities, wherein the control element respectively controls the first, second and third dynamic diffractive optical elements 321, 322, 323 to perform real-time signal modulation for producing dynamic diffractive grating distributions, so that the first, second and third color beams B21, B22, B23 pass through the first, second and third dynamic diffractive optical elements 321, 322, 323 respectively, for producing a pixel corresponding to a predetermined position of a specific space.

The combiner 35 is disposed at a location surrounded by the first dynamic diffractive optical element 321, the second dynamic diffractive optical element 322, and the third dynamic diffractive optical element 323, so that the first, second and third color beams B21, B22, B23 are combined at a corresponding predetermined position after passing through the first, second and third dynamic diffractive optical elements 321, 322, 323, respectively. In this embodiment, the combiner 35 is preferably an X-prism. The signal output element 34 is electrically connected to the control element 33 for outputting a pattern signal PS1 to the control element 33. In particular, the control element 33 is based on the pattern signal PS1 to respectively control the first, second and third dynamic diffractive optical elements 321, 322, 323 in a specific period to perform real-time signal modulation for producing different dynamic diffractive grating distributions, so that the first, second and third color beams B21, B22, B23 pass through the first, second and third dynamic diffractive optical elements 321, 322, 323 for producing the plurality of pixels in the specific space as defined by the pattern signal PS1, and the control element 33 respectively controls the first, second, and third dynamic diffractive optical elements 321, 322, 323 to be quickly switched to display each pixel, so that each pixel is projected on the corresponding position in the specific space to form the two-dimensional geometric image on an object 36 by scanning.

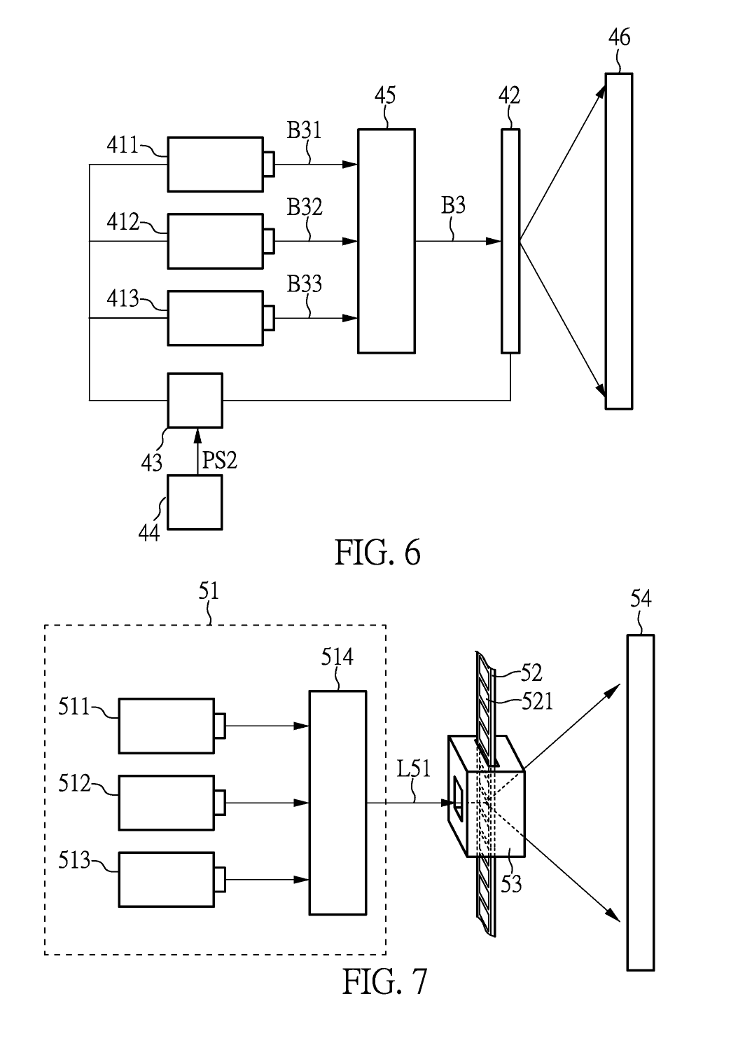

Please refer to FIG. 6, which is a schematic diagram of a free-space dynamic diffractive projection apparatus according to a still another preferred embodiment of the present invention. As shown in FIG. 6, the free-space dynamic diffractive projection apparatus comprises a first laser light source element 411, a second laser light source element 412, a third laser light source element 413, a dynamic diffractive optical element 42, a control element 43, a coupler 45, and a signal output element 44.

This embodiment is similar to the previous embodiment except that the single laser light source element 21 is expanded into three red, blue, green laser light source elements 411,412,413, so as to produce required color beam by combination.

The first laser light source element 411, the second laser light source element 412, and the third laser light source element 413 are disposed at locations so that the laser light source elements outputs thereof are in parallel with each other. The first laser light source element 411 provides a first color beam B31 with a first light intensity. The second laser light source element 412 provides a second color beam B32 with a second light intensity. The third laser light source element 413 provides a third color beam B33 with a third light intensity. In this embodiment, the first color beam B31 is preferably a red beam, the second color beam B32 is preferably a green beam, and the third color beam B33 is preferably a blue beam.

The combiner 45 is disposed at a location to which the first laser light source element 411, the second laser light source element 412, and the third laser light source element 413 output laser beams, so as to receive the first, second and third color beams B31, B32, B33 for combining the first, second and third color beams B31, B32, B33 into a combined beam B3. The combined beam B3 is then received by the dynamic diffractive optical element 42. In particular, the dynamic diffractive optical element 42 is preferably a spatial light modulator or a dynamic grating. In this embodiment, the dynamic diffractive optical element 42 is a spatial light modulator.

The control element 43 is electrically coupled with the first, second and third laser light source elements 411,412,413 and the dynamic diffractive optical element 42, for respectively dynamically adjusting the first, second, and third light intensities, wherein the control element 43 controls the dynamic diffractive optical element 42 to perform real-time signal modulation for producing dynamic diffractive grating distributions, so that the combined beam B3 passes through the dynamic diffractive optical element 42 for producing a pixel corresponding to a predetermined position of a specific space.

The signal output element 44 is electrically connected to the control element 43 for outputting a pattern signal PS2 to the control element 43. The control element 43 is based on the pattern signal PS2 to control the diffractive optical element 42 in a specific period to perform real-time signal modulation for producing different dynamic diffractive grating distributions, so that the combined beam B3 passes through the dynamic diffractive optical element 42 for producing the plurality of pixels in the specific space as defined by the pattern signal PS2, and the control element 43 controls the dynamic diffractive optical element 43 to be quickly switched to display each pixel, so that each pixel is projected on the corresponding position in the specific space to form the two-dimensional geometric image on an object 46 by scanning.

Please refer to FIG. 7, which is a schematic diagram of the free-space dynamic diffractive projection apparatus according to a further preferred embodiment of the present invention. As shown in FIG. 6, a free-space dynamic diffractive projection apparatus comprises a light source module 51, a hologram set 52, and a player 53.

The light source 51 provides a collimated beam L51. In this embodiment, the light source element may be a single laser light source element. Alternatively, the light source element may comprise three laser light sources 511, 512, 513 for providing red, blue, and green beams, respectively; and a combiner 514 for combining the red, blue and green beams into the collimated beam L51.

The hologram set 52 includes a plurality of cascaded diffractive optical elements, such as a plurality of holograms 521 that respectively define a plurality of pixels corresponding to a two-dimensional geographic image, each hologram 521 having static diffractive grating distribution, so as to produce a static diffractive image, i.e., the two-dimensional geometric image, when the collimated beam L51 passes through each of the holograms 521.

The player 53 is provided for fast playing the hologram set 52 so as to allow the static diffractive images produced from the plurality of holograms 521 to be presented on an object 54 as a dynamic image.

Therefore, the free-space dynamic diffractive projection apparatus of the present invention is able to control laser beams passing through the dynamic diffractive optical element to directly produce a two-dimensional dynamic diffractive geometric pattern, so as to replace the conventional technique of using a micro scanner to produce the two-dimensional dynamic image by scanning and projecting, and to be free from redundantly scanning the part of the transmission area on which no image is formed, thereby avoiding unnecessary energy loss.

Further, the free-space dynamic diffractive projection apparatus of the present invention can be substantially used in construction sites for measurement, wherein it is used not only for one-dimensional measurement, such as a horizontal line, a vertical line, and a gap, but also for different two-dimensional measurement, such as a rectangle, a circular, and a circular arc.

Although the present invention has been explained in relation to its preferred embodiment, it is to be understood that many other possible modifications and variations can be made without departing from the spirit and scope of the invention as hereinafter claimed.

What is claimed is:

1. A free-space dynamic diffractive projection apparatus, comprising:
a laser light source element for providing a color beam having a light intensity;
a dynamic diffractive optical element corresponding to the laser light source element for receiving the color beam;
a control element electrically coupled with the laser light source element and the dynamic diffractive optical element for dynamically adjusting the light intensity, wherein the control element controls the dynamic diffractive optical element to perform real-time signal modulation for producing dynamic diffractive grating distributions, so that the color beam passes through the dynamic diffractive optical element for producing a pixel corresponding to a predetermined position of a specific space; and
a signal output element electrically connected to the control element for outputting a pattern signal to the control element, wherein the pattern signal defines a plurality of pixels corresponding to a two-dimensional geometric image;
wherein the control element is based on the pattern signal to control the dynamic diffractive optical element in a specific period to perform real-time signal modulation for producing different dynamic diffractive grating distributions, so that the color beam passes through the dynamic diffractive optical element for producing the plurality of pixels in the specific space as defined by the pattern signal, and the control element controls the dynamic diffractive optical element to be quickly switched to display each pixel, so that each pixel is projected on the corresponding position in the specific space to form the two-dimensional geometric image by scanning.

2. The free-space dynamic diffractive projection apparatus of claim 1, wherein the dynamic diffractive elements is a spatial light modulator.

3. The free-space dynamic diffractive projection apparatus of claim 1, wherein the dynamic diffractive elements is a dynamic grating.

4. The free-space dynamic diffractive projection apparatus of claim 1, wherein the pattern signal is a two-dimensional pattern signal, and the two-dimensional geometric image corresponding to the two-dimensional pattern signal is a rectangle, a circular, an ellipse, a trapezoid, a polygon, a cruciform, or a circular arc.

5. A free-space dynamic diffractive projection apparatus, comprising:
a first laser light source element for providing a first color beam having a first light intensity;
a second laser light source element for providing a second color beam having a second light intensity;
a third laser light source element for providing a third color beam having a third light intensity;
a first dynamic diffractive optical element corresponding to the first laser light source element for receiving the first color beam;
a second dynamic diffractive optical element corresponding to the second laser light source element for receiving the second color beam;
a third dynamic diffractive optical element corresponding to the third laser light source element for receiving the third color beam;
a control element electrically coupled with the first, second and third laser light source elements and the first, second and third dynamic diffractive optical elements, for respectively dynamically adjusting the first, second and third light intensities, wherein the control element respectively controls the first, second and third dynamic diffractive optical elements to perform real-time signal modulation for producing dynamic diffractive grating distributions, so that the first, second and third color beams passes through the first, second and third dynamic diffractive optical elements, respectively, for producing a pixel corresponding to a specific position of a specific space;
a combiner for allowing the first, second and third color beams to be combined at the corresponding specific position after passing through the first, second and third dynamic diffractive optical elements, respectively; and
a signal output element electrically connected to the control element for outputting a pattern signal to the control element, wherein the pattern signal defines a plurality of pixels corresponding to a two-dimensional geometric image;
wherein the control element is based on the pattern signal respectively to control the first, second and third dynamic diffractive optical elements in a specific period to perform real-time signal modulation for producing different dynamic diffractive grating distributions, so that the first, second and third color beams pass through the first, second and third dynamic diffractive optical elements for producing the plurality of pixels in the specific space as defined by the pattern signal, respectively, and the control element respectively controls the first, second, and third dynamic diffractive optical elements to be quickly switched to display each pixel, so that each pixel is projected on the corresponding position in the specific space to form the two-dimensional geometric image by scanning.

6. The free-space dynamic diffractive projection apparatus of claim 5, wherein each of the first, second and third dynamic diffractive elements is a spatial light modulator.

7. The free-space dynamic diffractive projection apparatus of claim 5, wherein each of the first, second and third dynamic diffractive elements is a dynamic grating.

8. The free-space dynamic diffractive projection apparatus of claim 5, wherein the pattern signal is a two-dimensional pattern signal, and the two-dimension geometric image corresponding to the two-dimensional pattern signal is a rectangle, a circular, an ellipse, a trapezoid, a polygon, a cruciform, or a circular arc.

9. The free-space dynamic diffractive projection apparatus of claim 5, wherein the first color beam is a red beam, the second color beam is a green beam, and the third color beam is a blue beam.

10. The free-space dynamic diffractive projection apparatus of claim 5, wherein the combiner is an X-prism.

11. A free-space dynamic diffractive projection apparatus, comprising:
a first laser light source element for providing a first color beam having a first light intensity;
a second laser light source element for providing a second color beam having a second light intensity;
a third laser light source element for providing a third color beam having a third light intensity;
a combiner for receiving the first, second, and third color beams and combining the first, second and third color beams into a combined beam;
a dynamic diffractive optical element for receiving the combined beam;
a control element electrically coupled with the first, second and third laser light source elements, and the dynamic diffractive optical element, for respectively dynamically adjusting the first, second, and third light intensities, wherein the control element controls the dynamic diffractive optical element to perform real-time signal modulation for producing dynamic diffractive grating distributions, so that the combined beam passes through the dynamic diffractive optical element for producing a pixel corresponding to a predetermined position of a specific space; and
a signal output element electrically connected to the control element for outputting a pattern signal to the control element, wherein the pattern signal defines a plurality of pixels corresponding to a two-dimensional geometric image;
wherein the control element is based on the pattern signal to control the diffractive optical element in a specific period to perform real-time signal modulation for producing different dynamic diffractive grating distributions, so that the combined beam passes through the dynamic diffractive optical element for producing the plurality of pixels in the specific space as defined by the pattern signal, and the control element controls the dynamic diffractive optical element to be quickly switched to display each pixel, so that each pixel is projected on the corresponding position in the specific space to form the two-dimensional geometric image by scanning.

12. The free-space dynamic diffractive projection apparatus of claim 11, wherein the dynamic diffractive elements is a spatial light modulator.

13. The free-space dynamic diffractive projection apparatus of claim 11, wherein the dynamic diffractive elements is a dynamic grating.

14. The free-space dynamic diffractive projection apparatus of claim 11, wherein the pattern signal is a two-dimensional pattern signal, and the two-dimensional geometric image corresponding to the two-dimensional pattern signal is a rectangle, a circular, an ellipse, a trapezoid, a polygon, a cruciform, or a circular arc.

15. The free-space dynamic diffractive projection apparatus of claim 11, wherein, the first color beam is a red beam, the second color beam is a green beam, and the third color beam is a blue beam.

16. The free-space dynamic diffractive projection apparatus of claim 11, wherein the combiner is an X-prism.

17. A free-space dynamic diffractive projection apparatus, comprising:
a light source module for providing a collimated beam;
a hologram set including a plurality of holograms defined a plurality of pixels corresponding to a two-dimensional geometric image, wherein each hologram has static diffractive grating distribution, so as to produce a static diffractive image when the collimated beam passes through each of the holograms; and
a player for fast playing the plurality of holograms for allowing the static diffractive images produced from the plurality of holograms to be presented as a dynamic image, so as to form the two-dimensional geometric image.

18. The free-space dynamic diffractive projection apparatus device of claim 17, wherein the light source module comprising;
three laser light source elements for providing a red beam, a blue beam, and a green beam, respectively; and
a combiner for combining the red, blue and green beams into the collimated beam.
